(19) United States
(12) Patent Application Publication
(10) Pub. No.: US 2014/0379598 A1
(43) Pub. Date: Dec. 25, 2014

(54) METHOD AND SYSTEM FOR REGULATING CONTENT POSTED ON SOCIAL MEDIA SITES

(71) Applicant: Harvest Exchange Corporation, Chicago, IL (US)

(72) Inventors: Michael PERRONE, Chicago, IL (US); Peter HANS, Chevy Chase, MD (US)

(21) Appl. No.: 13/926,609

(22) Filed: Jun. 25, 2013

(51) Int. Cl. G06Q 50/00; G06Q 30/00

(52) U.S. Cl. CPC G06Q 50/01; G06Q 30/018
USPC 705/319

(57) ABSTRACT

Method and system for regulating an employee's posting of company information on social media, for example to ensure that the content complies with disclosure rules relating to company financial or investment information. The employee designates a compliance officer, who is not required to be a member of the social media community (SMC) or to log into the community, to pre-approve postings by the company employee. A compliance module connects with the company's internal email system providing a mechanism for communication pre-approval requests of content to the officer and for storing the approved posts in order to comply with regulated company's record-keeping requirements.

### FIELD OF THE INVENTION

The present invention relates to the regulation of online content, and more particularly to a method and system for regulating content posted by members of an online social media community to ensure for example, that the content complies with disclosure rules relating to financial or investment information.

### BACKGROUND

Historically, regulated companies have only communicated financial information to the public (e.g., investors) through tightly controlled channels and following strict protocols to avoid violating government regulations, e.g., issued by the U.S. Securities and Exchange Commission (SEC). A company has typically announced financial or other key information by simultaneously sending out the information to an established news media that provides “equal access to material information”, in practice meaning via the Dow Jones News Service, along with submitting a formal SEC filing. In the early 1990's, the SEC created an electronic filing room, allowing investors to access SEC filings on the Internet. However, it was not until much later (2008), that the SEC allowed companies themselves to publish information on the Internet by, for example, a posting on the company's website. This was considered an “equal access” publication, readily accessible to the public, and enabled the company to maintain control over the disclosed content. It is only very recently that the SEC ruled that posting on social media sites, such as Facebook and Twitter, could be used along with news releases and company websites, as long as the company has told investors which outlets they intend to use. Again however the assumption is that the company will author and publish any such posts on the company homepage of the social media site, to ensure compliance.

Regulated companies (e.g., with publically traded shares) that are subject to government financial/securities regulations have internal protocols for ensuring compliance with fair disclosure rules. A company's internal compliance officer or department will typically review and determine the content posted on a company website or distributed to news outlets. The company also has an internal record keeping policy for maintaining accurate records of publically disclosed financial or investment related content, including the period of time such records are maintained.

However, such companies have many employees with potential access to internal (nonpublic) information concerning the company, which information may be of interest to investors and/or considered sensitive information subject to fair disclosure and publication rules. As employees use of social media sites has exploded, for both personal and business uses, the potential for deliberate or inadvertent disclosure of sensitive information by any one employee has sky-rocketed. Because there has been no effective way to regulate such disclosures via social media, the compliance office has essentially two options, they can 1) ban use of social media at the workplace (which is common) or 2) require that all posts be manually submitted for compliance/legal pre-approval and then the officer will actively monitor the community to ensure that the employees are not entering content that they should not be or has not been approved. Neither of these options are particularly effective. The compliance officer's only way of regulating is by constantly observing the online community and its members who are employees of the company. The compliance officer cannot possibly adequately supervise everyone and everything. Even if the company has a policy that all posts must have prior approval, the office cannot ensure that everything that is posted has been submitted for approval. Further, even if the compliance officer approves a post, the post can still be edited prior to submission by the author. This makes it difficult, if not impossible, for the compliance office to regulate since the office would not assume that anything within the approved post had been changed.

It would be highly desirable to provide a tool, a system and method, to more effectively determine and control the dissemination of company information by employees on social media in a manner that does not violate the regulatory requirements covering financial or other information of the company.

### SUMMARY OF THE INVENTION

Methods and systems are provided for regulating the dissemination of company information via social media. The invention allows easy access for a compliance officer, designated by an employee, to monitor an employee's use of social media. This is particularly relevant for businesses in highly regulated industries with specific and strict approval and record keeping requirements.

In accordance with the invention, the designated compliance officer is not required to be a member of the social media community or to log into the community in order to properly supervise or pre-approve contributions by the company's employee.

In accordance with one embodiment of the invention, a compliance module connects the online community with a company's internal email system providing a mechanism for submitting preapproval requests of content and for meeting the regulated company's record keeping requirements (e.g., by storing of emails).

In one embodiment, a compliance officer can approve or reject any and all social media content submissions by all employees of the regulated company, without requiring a significant change in the workflow of such employees making content submissions. In addition, the workflow for the compliance officer is simply to read an email and then either approve or reject content. The compliance module ensures that the employee cannot edit, in any fashion, a content submission that has not been approved by the compliance officer. And an employee also cannot post any content that has not been approved.

In one embodiment, the compliance module allows a member of a social media community “SMC” to designate a compliance officer, establishing that approval of the officer is required prior to online postings by the member. The compliance officer or member can also attach disclosures or disclaimers to the member profile that will then follow the employee's content throughout the site.

The invention thus overrides the posting ability of a social media community member by designating a compliance officer and by allowing that officer to have full approval or denial power over all posting content by the member.

In one embodiment the member is an employee of a regulated company and the employee designates someone employed by the company (e.g., a company compliance officer or supervisor) as his “designated compliance officer”. However, the invention is not so limited. The member may not be an employee of a regulated company. The member may designate as a compliance officer a publicist or other advisor. Various other alternative embodiments are discussed below along with other benefits and features of the invention.

In accordance with one embodiment of the invention, a method is provided for regulating content posted by members of an online social media community (SMC) comprising:
storing, on a compliance service provider module, a designated compliance officer for regulating posts by a member of an online social media community (SMC);
receiving, on a portal of the compliance module, content submitted by the member of the SMC;
the compliance module generating and sending to the designated compliance officer an email with the content and an automated reply link designating approval or denial, prior to posting of the content on the SMC;
the compliance module awaiting receipt of an automated reply from the compliance officer with approval or denial of the content;
wherein the content is posted on the SMC only after receipt of an approval reply from the compliance officer.

In one embodiment, the email and automated reply are stored.

In one embodiment, maintaining a compliance database of associated isers (members), designated officers and content.

In one embodiment, the member and compliance officers are employees of a regulated company.

In one embodiment the method includes:
storing the email and automated reply for each content submitted by one or more members employed by a regulated company for complying with record keeping requirements of investment or financial related content of the regulated company.

In one embodiment, the portal of the compliance module is operative to display a designation form for entry of the designated compliance officer by the member, and a content submission form for entry of content by the member.

In one embodiment, the compliance module communicates with one or more SMCs for transmitting approved content to the SMC for posting.

In one embodiment, the member communicates with the compliance portal via a computer, server or other wired or wireless communications device.

In one embodiment, the compliance officer communicates with the compliance module by a computer, server or other wired or wireless communications device.

In one embodiment the method includes:
receiving on the portal of the compliance module an email address of a compliance officer for the member; and
the compliance module generating and sending to the compliance officer an email with an automated reply link designating approval or denial of responsibility to approve content submitted by the member;
the compliance module awaiting receipt of an automated reply from the compliance officer with approval or denial of responsibility,
wherein the compliance officer is stored on the compliance module as a designated compliance officer for the member only after receipt of an approval reply from the compliance officer.

In one embodiment the method includes:
storing the approval of responsibility reply received from the compliance officer.

In one embodiment the method includes:
the compliance module, upon receipt of an automated reply from the compliance officer with denial of the content, generates and sends an email to the member alerting the member of the denial.

In one embodiment, the compliance module is integrated with an SMC.

In one embodiment, the compliance module is separate from the SMC.

In one embodiment, the compliance database includes member, compliance officer, and content tables linked by a member identifier.

In one embodiment, the compliance database includes a token identifier for associating the compliance officer with the content submitted by the member.

In one embodiment, the compliance portal is operative to display a member webpage listing one or more contents submitted by the member for which an approval reply has been received or is awaiting receipt.

In accordance with another embodiment of the invention, a data processing system is provided for regulating content posted by members of an online social media community (SMC), comprising a plurality of computers interconnected by a communications network, the system comprising a plurality of system means operative to cause the system to operate in a respective plurality of different states;
a first logic means for controlling a first state in which content may be entered into said system by a member, said first logic means being operative to generate an email with the content and an automated reply link designating approval or denial of the content; and
a second logic means for controlling a second state in which content is approved or denied in response to receipt of an automated reply from a designated compliance officer for the member with approval or denial of the content;
wherein said first logic means is operative
a. to generate said email for each content submitted by the member; and
b. to send to the designated compliance officer the email with the content and automated reply designating approval or denial prior to posting the content on the SMC;
and said such second logic means is operative to await receipt of an automated reply from the designated compliance officer with approval or denial of the content, wherein the content is posted on the SMC only after receipt of an approval reply from the designated compliance officer.

In accordance with another embodiment of the invention, a computer system is provided including hardware and software for processing content submissions and communications between at least one employee of a regulated company that is a member of an online social media community (SMC) and a designated compliance officer, the system comprising:
a communications network connecting the member and the designated compliance officer of the member;
a compliance module connected to the network for processing a content submission by the member to the SMC, including generating and sending an email to an email inbox of the designated compliance officer via the network, the email including the submitted content for preapproval by the compliance officer prior to posting on the SMC;
the compliance module awaiting receipt of a reply via the network from the compliance officer and posting the content on the SMC only after receipt of a reply from the compliance officer that approves the content.

### BRIEF DESCRIPTION OF THE DRAWINGS

FIG. 1 is a schematic block diagram of a compliance module communicating with a regulated company and social media for controlling the dissemination of company information by employees on social media in accordance with one embodiment of the invention;

FIG. 2 is a schematic diagram of a system architecture for a communication network according to one embodiment of the invention;

FIG. 3 is a flow chart of a process for a user to designate a compliance officer according to one embodiment of the invention;

FIG. 4 is a flow chart of a process for a user to submit content for approval by the designated compliance officer according to one embodiment of the invention;

FIG. 5 is a schematic illustration of certain network communications between the user, compliance service provider, compliance officer and social media communities (SMCs) according to one embodiment of the invention;

FIG. 6 illustrates one example of the user entry form for content submission by a user according to one embodiment;

FIG. 7 is a schematic diagram of communications between an integrated compliance module and SMC with extended (external) social media communities according to one embodiment;

FIG. 8 illustrates one example of a database schema for implementing one embodiment of the invention;

FIGS. 9A-9I are screen shots taken from a compliance portal and messages generated by the compliance module according to one embodiment;

FIG. 9A is one example of a user homepage;

FIG. 9B is an example of a webpage for a user to enter his profile information;

FIG. 9C is an example of a webpage for a user to designate his compliance officer;

FIG. 9D illustrates one example of a notification email sent to the designated compliance officer;

FIG. 9E illustrates one example of a compliance module webpage enabling the user to submit content for approval;

FIG. 9F illustrates one example of an email sent to the compliance officer for approval of content;

FIG. 9G is one example of a message sent to the compliance officer confirming his approval of the content submission;

FIG. 9H is one example of a message sent to the compliance officer regarding his denial of a content submission with a window for entering reasons for such denial;

FIG. 9I is one example of an email sent to the user concerning denial of his content submission and providing an option to edit and resubmit content;

FIG. 10 is a block diagram illustrated an exemplary computer system that may be used in one embodiment of the invention; and

FIG. 11 is a block diagram illustrating a server that can be used in one embodiment of the invention.

### DETAILED DESCRIPTION

Various embodiments of the present invention are now described with reference to the drawings. In the following description, for purposes of explanation, numerous specific details are set forth in order to provide a thorough understanding of one or more implementations of the present invention. It will be evident, however, that the present invention may be practiced without these specific details. In other instances, well-known structures and devices are shown in block diagram form in order to facilitate describing the present invention.

As used in this application, the terms “module”, “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers (e.g., on a network, which may be the Internet).

The present invention may also be illustrated as a flow chart of a process of the invention. While, for the purposes of simplicity of explanation, the one or more methodologies shown in the form of a flow chart are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

In various embodiments of the invention disclosed herein, the term “social media community” (SMC) is used to identify a private virtual online network of people who create, share, and exchange information and ideas on the internet through the use of a software application and/or website by way of a connected computing device. By “private” it is meant that to participate a person must first join and be approved as a member of the community.

A “member” means a person who has registered (been approved) to be part of a social media community with privileges allowing them to interact with other people within the virtual community.

A “regulated company” is used to identify a company in the investment or financial services industry who's employees social media content contributions are subject to supervisor oversight in accordance with the rules sets forth by a government agency regulating that company (SEC, FINRA etc.).

A “compliance officer” means a person designated by a member to approve the member's content submissions prior to posting on the SMC.

A “compliance service provider” provides a wired or wireless network based service to a member for obtaining pre-approval of SMC posts and for communicating with the member and the designated compliance officer in this regard. For example, the service may be implemented via a server (a compliance module) to provide an application web-based data processing service and interface to one or more other computers, servers, or other wired or wireless communication devices (e.g., cell phone, tablet computer, etc.) of the one or more members, compliance officers and social media communities. The services of the compliance provider and the compliance module may be implemented on one or more computer systems that are owned, leased or operated on behalf of the compliance service provider (e.g., on a server farm or cloud).

An “automated reply” means a button or link provided in an email generated by the compliance module that enables a compliance officer to submit a designated reply (e.g., approval or denial) to the compliance module by simply clicking on the button. As used herein, button and link means the same mechanism (are used interchangeably).

### A. System and Method for Regulating Content

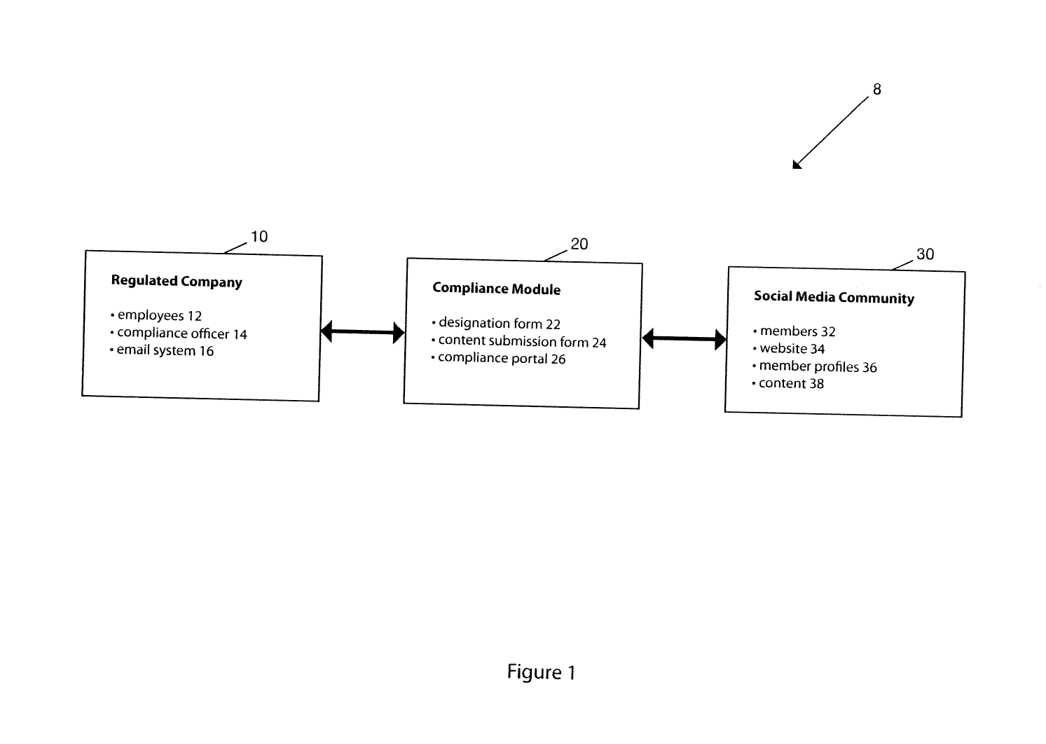

FIG. 1 illustrates a high level block diagram of a system according to one embodiment of the invention for regulating a member's use of social media. In this embodiment, a communications network 8 includes a compliance module 20 that connects a regulated company 10 and a social media community (SMC) 30. The regulated company 10 has employees 12, at least one compliance officer 14 and an email system 16. The social media community 30 includes members 32, a website 34, member profiles 36, and content 38. In this embodiment, the compliance module 20 connects with the company's internal email system 16 to:
enable an employee 12, who is a member 32 of community 30, to designate a compliance officer 14 (via designation form 22) for required pre-approval of all content 38 posted by the member 32 on the community website 34, the pre-approval process comprising the employee's submission of proposed content via a content submission form 24 to the compliance module,
upon receipt of a completed content submission form 24, the compliance module generating an email with the submitted content and an automated reply link (for approval or denial) that is sent to the designated compliance officer 14,
the designated compliance officer 14 reviews the content in the email and submits an automated reply via a compliance portal 26 (of module 20) which automated reply approves or rejects the content, wherein the submitted content is posted to the SMC only after receipt of an automated reply from the compliance officer designating approval of the content; and
the company email system 16 maintains a record of the content and approval e.g., by storing the automated reply on the company's data storage system.

The compliance module thus ensures that an employee cannot edit or otherwise post a content submission that has not been approved by the compliance officer. The employee also cannot post any content that has not been approved, or has been rejected.

### B. System Architecture

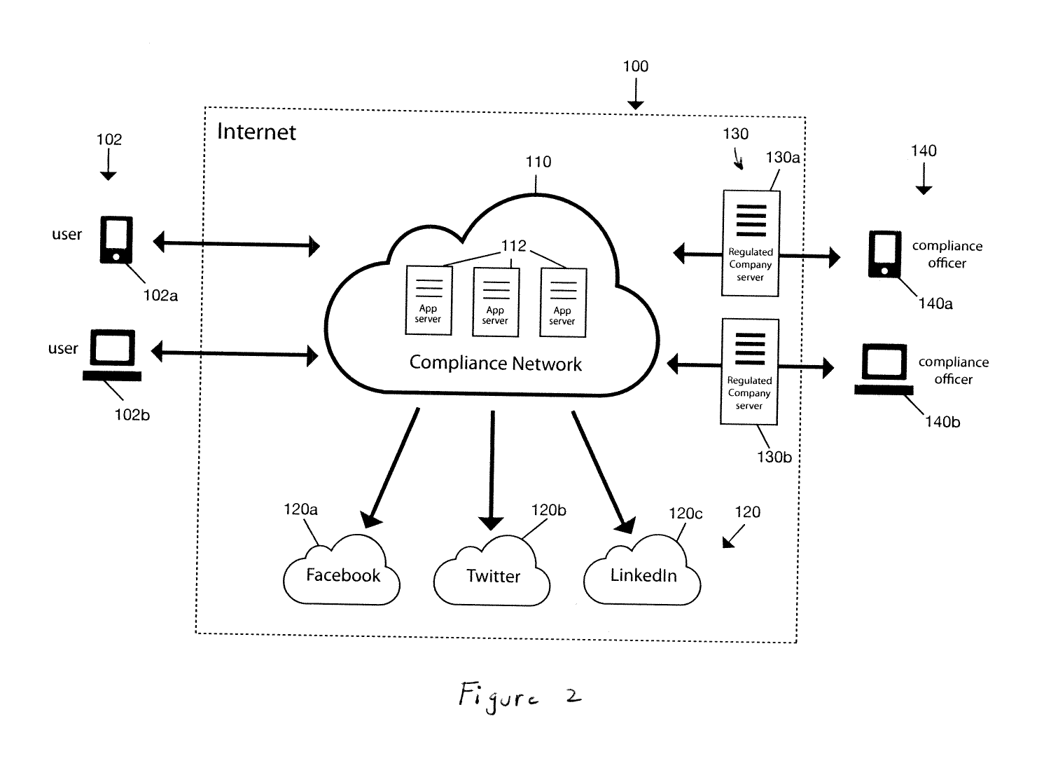

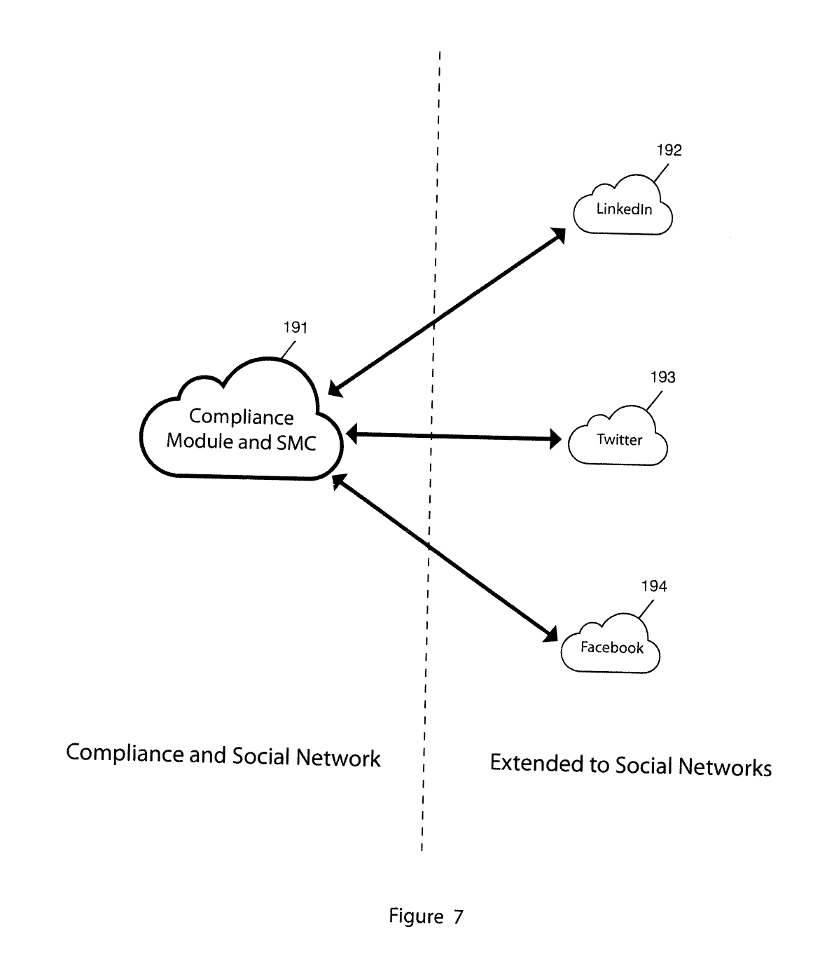

FIG. 2 illustrates in more detail one embodiment of a system architecture for implementing the present invention. A networked communications system 100 connects users 102, that join the compliance network 110, the users submitting content to the compliance network 110 for desired publication on one or more social media communities 120 (such as Facebook 120a, Twitter 120b, and LinkedIn 120c). The content submissions to the network 110 are stored on one or more application servers 112. For each submission, server 112 generates an email with an automated approval/denial reply link in the email and the email is transmitted to the email server 130 of the regulated company employing the designated compliance officer 140 for the respective submission. A user can access the compliance network by an application on a wireless mobile device 102a, or on a desktop computer 102b. The users access an application stored on the application server 112 that includes a designation entry form for the user to designate a compliance officer (e.g., 140a or 140b), as well as a content submission form for entering desired content for posting on one or more of the social media sites (120a, 120b, 120c). In one embodiment, the compliance network 110 itself may also comprise a social media community and thus publish any approved content on the network 110 (see FIG. 7). In other embodiments the compliance network forwards the approved content to one or more separate social media communities 120.

Each regulated company server 130a, 130b includes an email system (of the respective company) for communicating with the compliance network 110. In one embodiment, a compliance officer employed by the company accesses his company email server 130a (which in turn accesses network 110) via a wireless mobile communications device 140a, or via a desktop computer 140b. The officer's automated reply (a link in the email) is received by server 112 and may be stored both on compliance server 112 and the company server 130. It will be apparent to one skilled in the art that the invention may be practiced without these particular details, which are presented as examples only.

### B. Method and System Embodiments

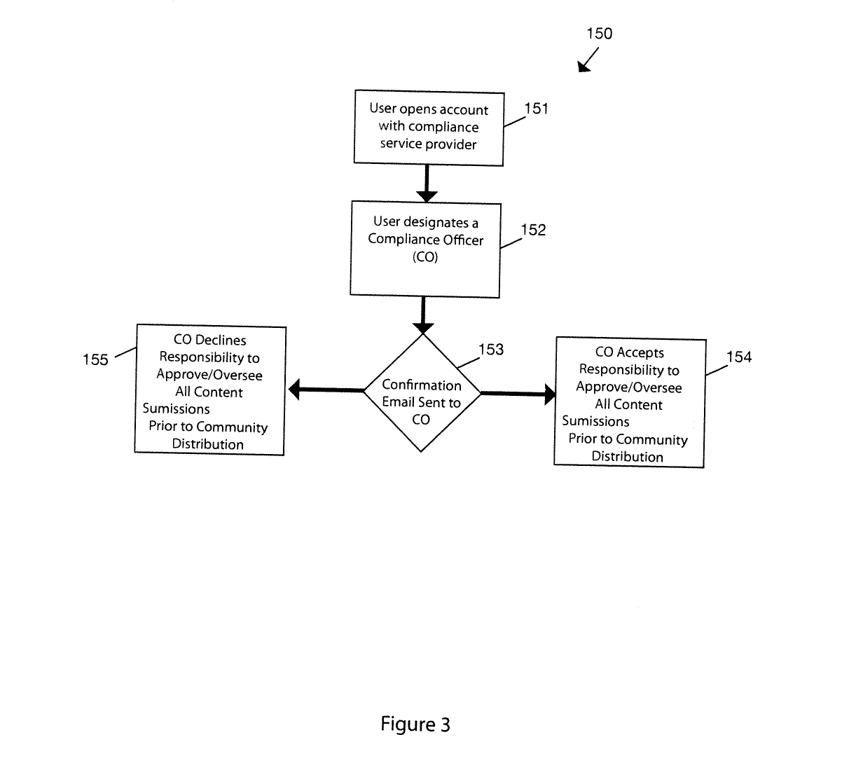

Referring now to FIG. 3, there is illustrated a flow chart of a process 150 for regulating a member's use of social media according to one embodiment of the invention. Beginning at step 151, a user opens an account with a compliance service provider.

At next step 152, the user designates a compliance officer for approval of all content submissions to a SMC. As previously described, the compliance officer may be an employee or other authorized agent of the company that employs the user, where the user wishes to comply with his employer's compliance procedures. At 153, the service provider sends a confirmation email to the designated compliance officer (e.g., to the email address of the officer provided by the user). The email may contain one or more links to a portal (e.g., webpage) of the service provider, whereby by clicking on an approval link the compliance officer accepts responsibility to approve and oversee all content submissions by the user to a community. Another link notifies the service provider that the compliance officer is refusing responsibility. Upon receipt of such denial, the service provider may notify the user of the denial and optionally provide an opportunity for the user to designate another compliance officer.

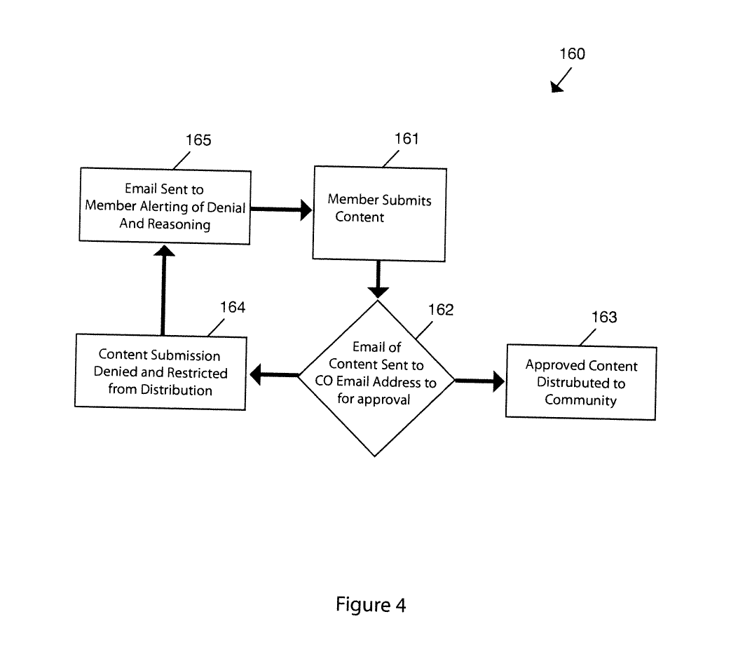

Referring now to FIG. 4, there is illustrated a flow chart of a process 160 for a user of the compliance service to submit content for approval. In a first step 161, the user submits a proposed content to the compliance service provider module, such as via a content submission entry form on the provider's website. At 162, the service provider generates and transmits an email of the content to the designated compliance officer's email address, requesting approval of the content. At 163, the compliance officer notifies the service provider module of approval of the content, and the service provider module thereafter distributes the content to one or more social media communities. Alternatively, at 164 the compliance officer denies the content submission, in which case it is not distributed to the community. Instead, at 165 an email is sent to the user alerting him to the denial and any reasoning provided by the compliance officer for the denial. The process returns to step 161 awaiting further content submissions by the user.

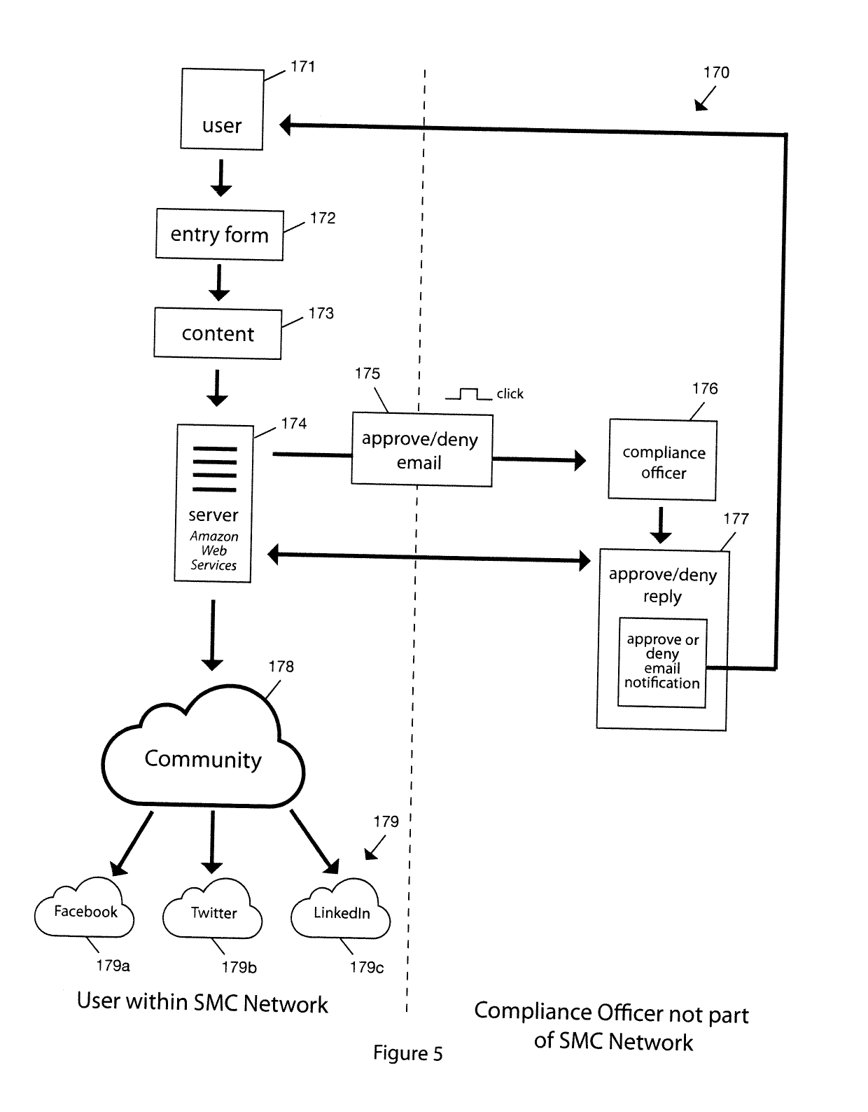

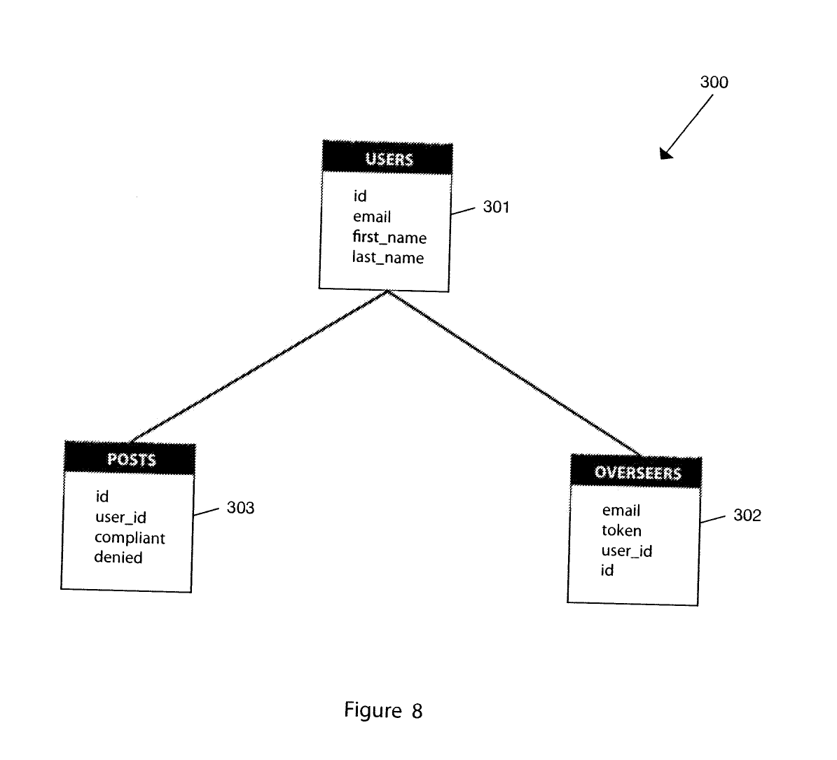

FIG. 5 is a schematic illustration of certain network communications 170 between the user 171, compliance service provider 172-174, compliance officer 176 and social media communities 178-179. In this embodiment, a user 171 accesses an entry form 172, provided on the compliance network (e.g., a webpage); the user enters content 173 on the entry form and the completed form is submitted to a server 174 on the compliance network for storage and association with a designed compliance officer (see e.g., database schema of FIG. 8). The server generates an approval/denial email 175 that is transmitted to the email address of the compliance officer 176. The compliance officer clicks on the automated reply link in the email to access the compliance network, e.g., via a webpage 177, that enables the compliance officer to enter his approval or denial of the proposed content. The approval or denial is optionally transmitted, e.g., by email, to the user 171 who made the content submission. If the compliance officer approves the request on the compliance server, the compliance service provider 178 transmits the approved content to one or more social media communities for publication (e.g., posting). The social media community may be part of the compliance network 178 or the compliance network may transmit the approved content to other social communities 179 such as Facebook, Twitter and LinkedIn 179a, 179b, 179c.

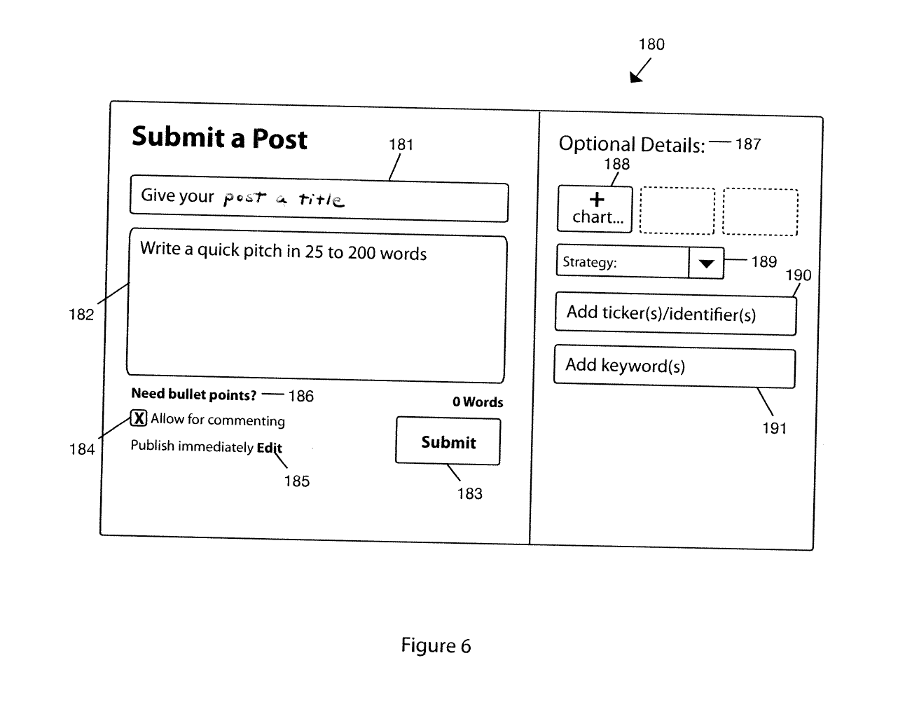

Referring now to FIG. 6, there is illustrated one example of a user entry form 180 for content submission. In this embodiment, the submission form prompts the user to “Submit a Post”, in other words to submit content for intended distribution on social media. In a first entry window 181, the user can enter a title for the submission. In another window 182, the user can enter the content, typically a limited number of words or characters. A button or link 183 is provided for the user to submit the content for approval. A button 184 is provided to designate (allow) viewers of the content on social media to comment on the published content. A link entitled “Need Bullet Points?” 186 enables a user to review and select from a list of predetermined content to be added to the submitted content. A “Publish immediately Edit” link 185 is selected by the user to specify an exact date and time to publish and distribute the content on social media. On the right side of the entry form webpage, optional details 187 are provided to the user. For example, by clicking button 188, the user can upload one or more versions of content in the form of chart, for inclusion in the submitted content. A pull-down menu 189 labeled “Strategy”, enables a user to select from predefined investment strategies to be included in the content submission. A window 190 enables the user to enter stock ticker identifiers, again for inclusion with the submitted content. Another window 191 allows the user to add keyword(s) to the content submission.

Referring now to FIG. 7, there is illustrated one embodiment of the invention wherein the compliance service provider 191 also comprises a social media community, along with providing the compliance services. This compliance community is further shown communicating with one or more extended social networks, separate from the compliance network, such as LinkedIn 192, Twitter 193 and Facebook 194.

### C. Example of Database Schema and Compliance Portal

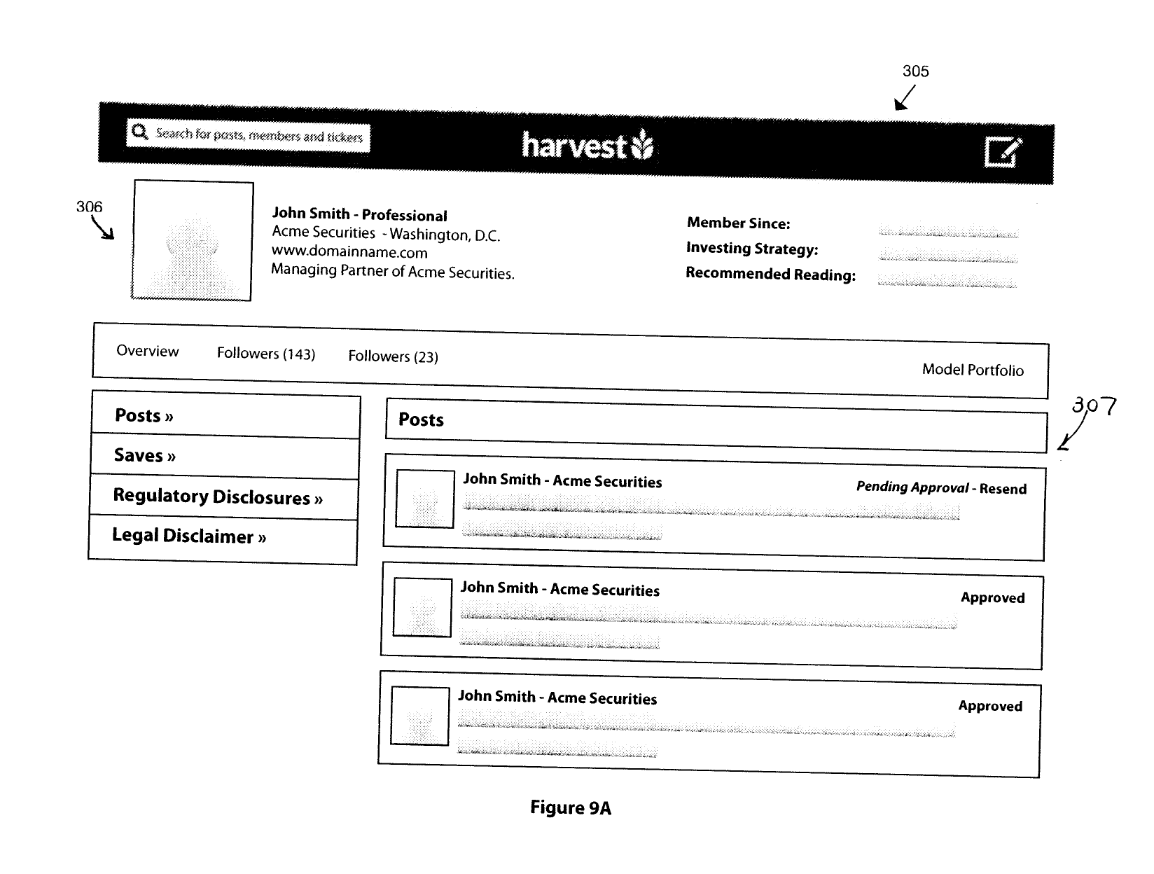

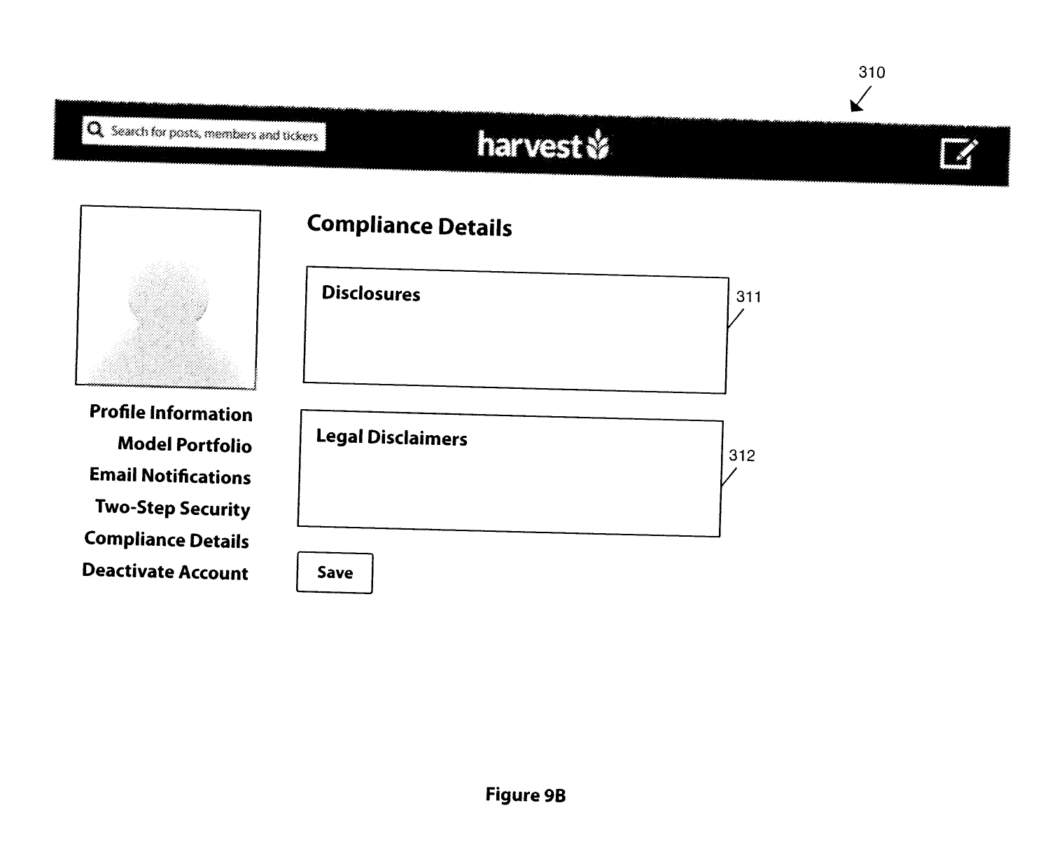

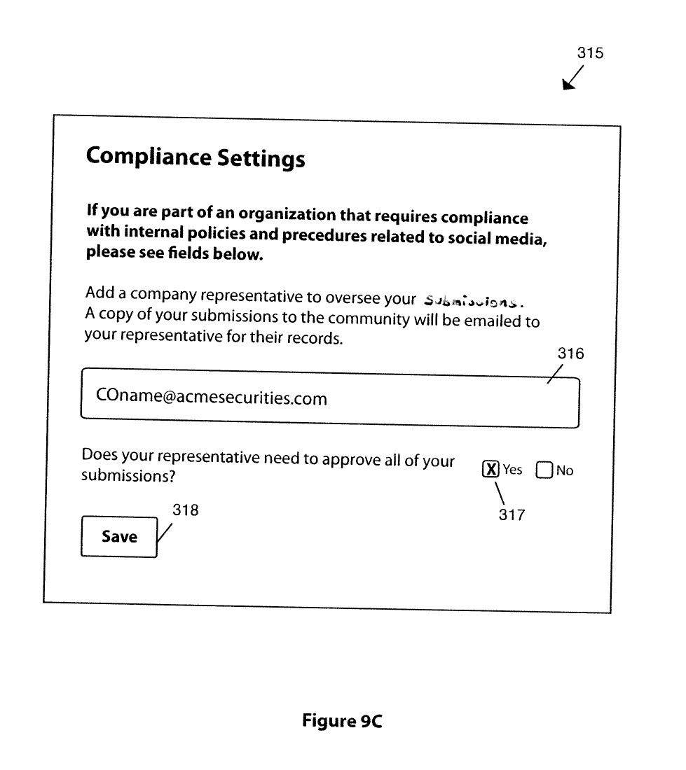

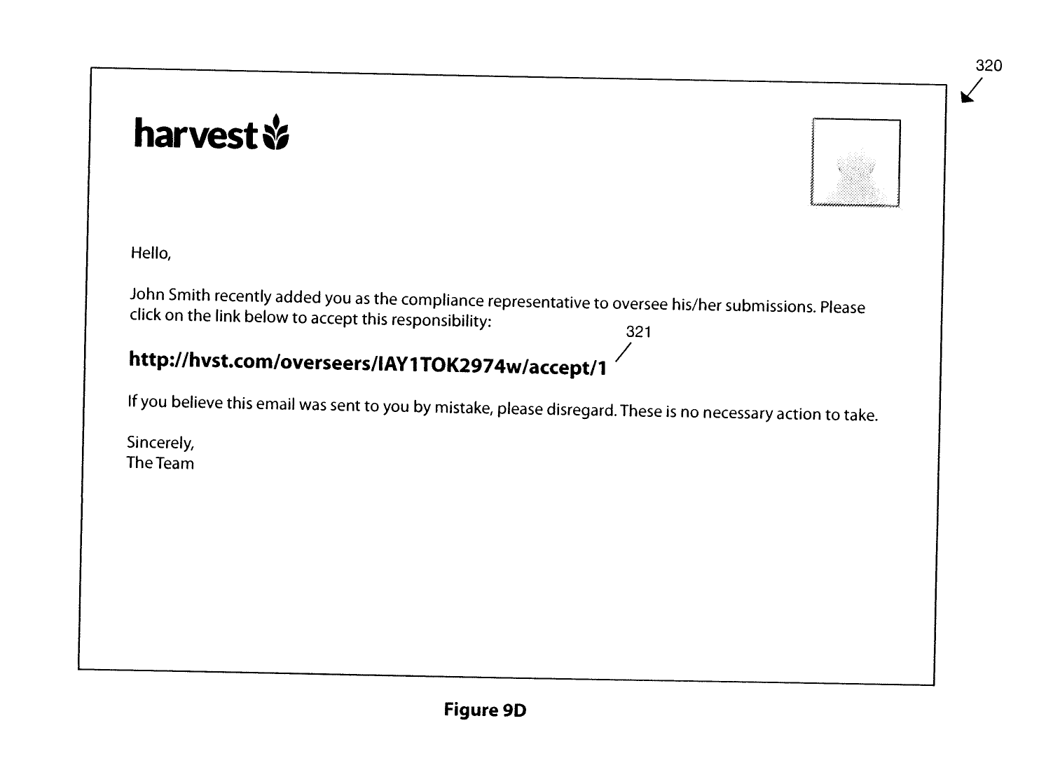

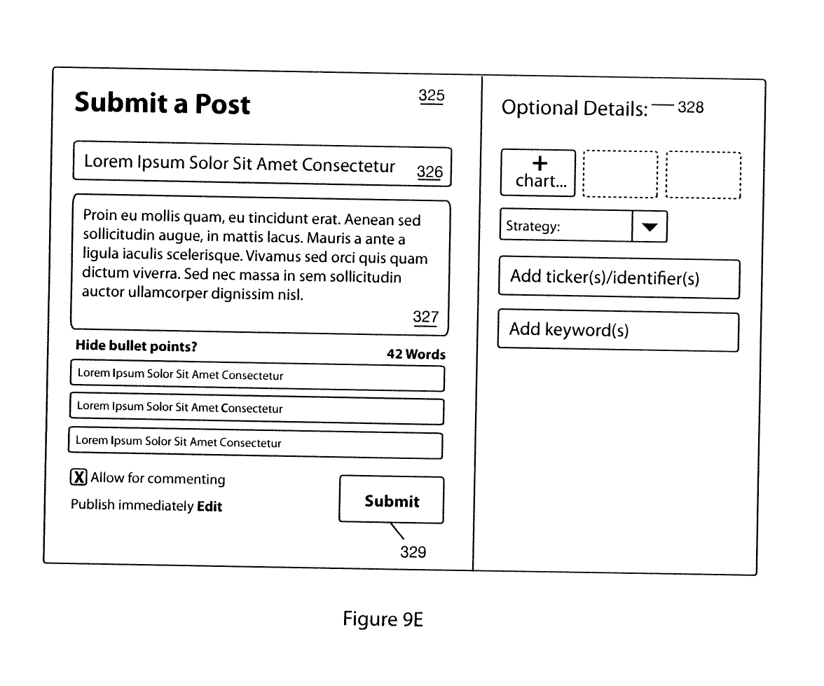

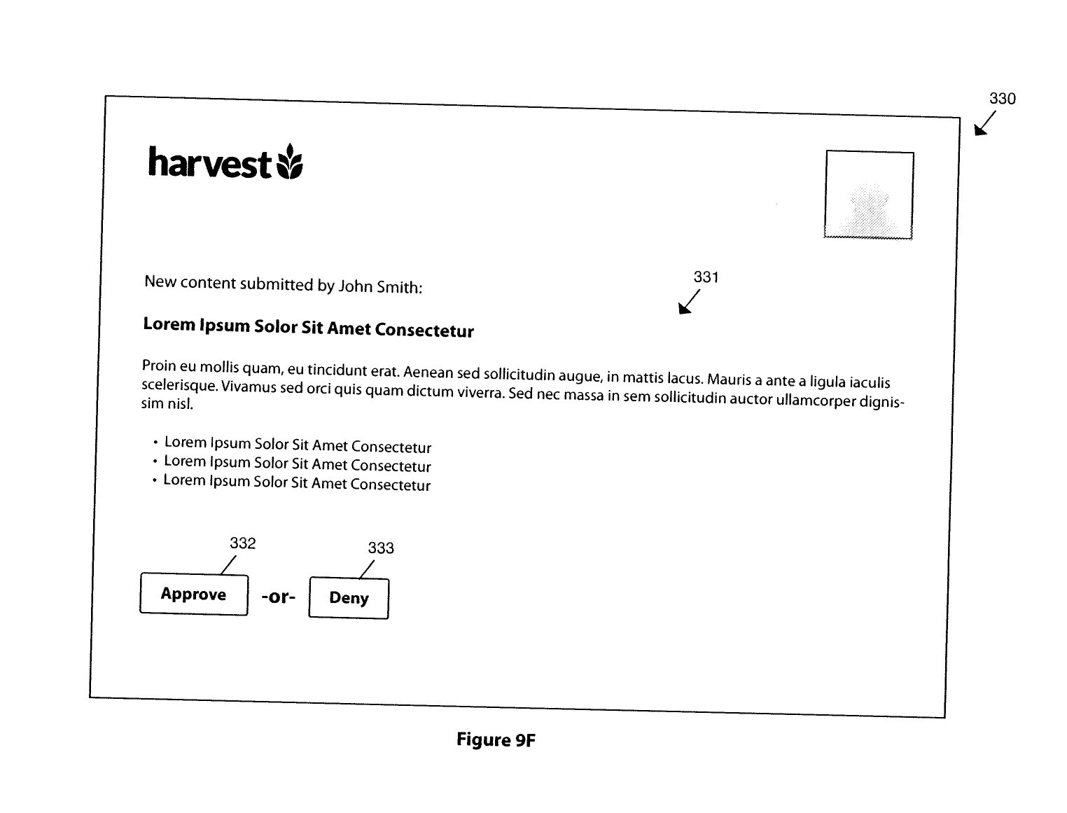

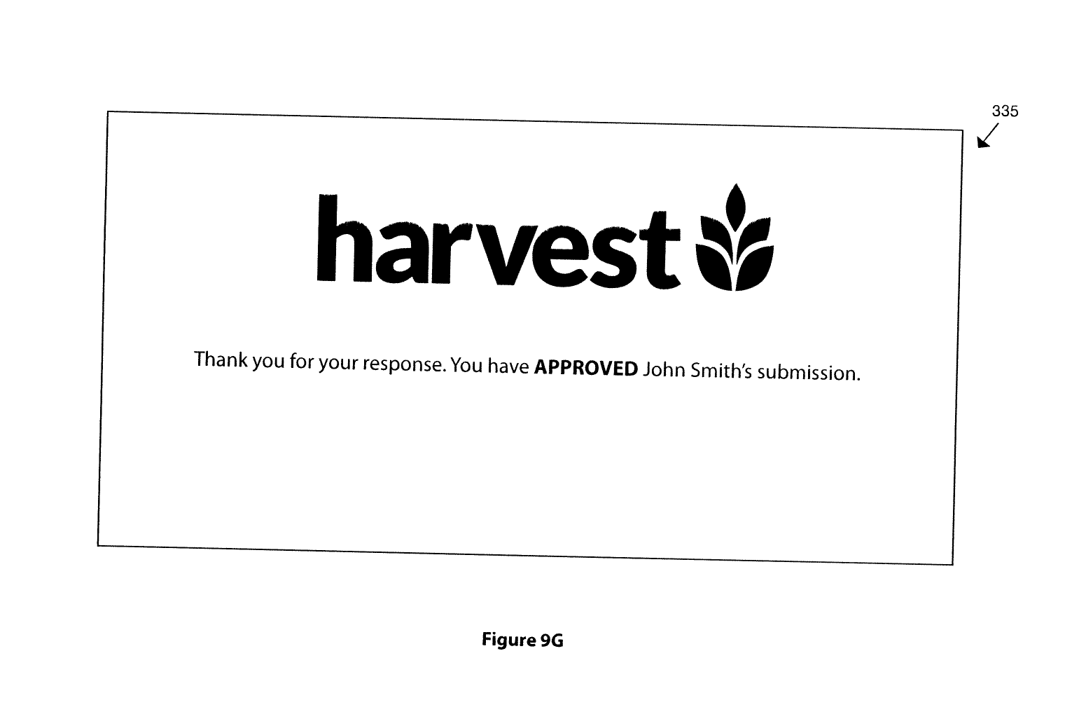

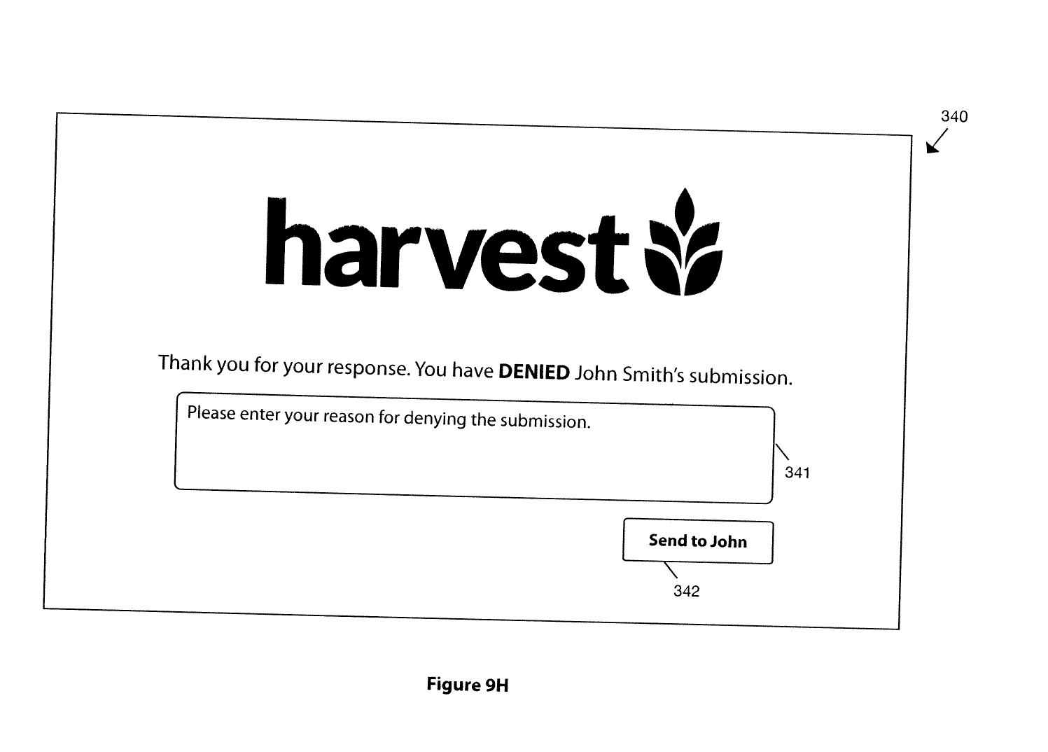

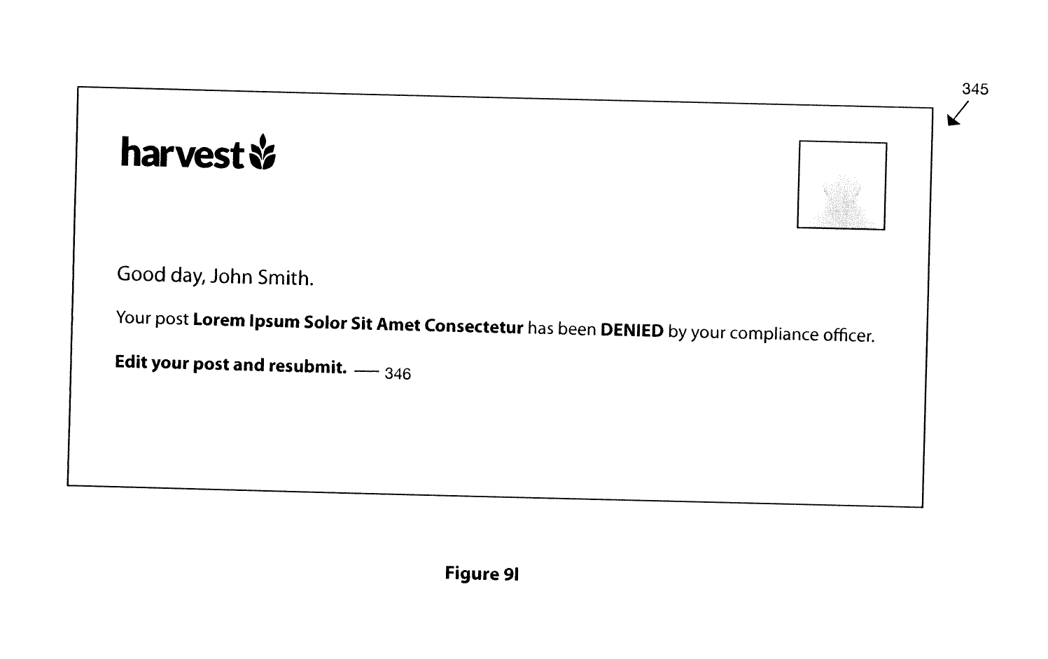

FIGS. 8-9 illustrate one example of a database schema and compliance portal for implementing one embodiment of the invention. FIG. 8 is a database schema (e.g., MySQL) including three tables identified as: users 301, overseers (compliance officers) 302, and posts (content) 303. Each registered user of the compliance network has a record which contains a user Id, user email address, and user first and last name. Each designated compliance officer has a record which includes the officer's email address, an identifier (token) for associating an email with a specific officer, a user Id identifying the user that designated the officer, and the officer Id. Each post (content) has a record that includes a content Id, a user Id, a compliant (approved) content or a denied content. The use of this database schema will be described further below for implementing a specific example of the invention.

FIGS. 9A-9I are screenshots taken from the compliance portal or emails generated by the compliance module.

FIG. 9A is one example of a user homepage 305 on the compliance portal which includes the user's contact and other identifying information 306, and a list of posts (content postings) 307 that have been submitted for approval or have previously been approved. For example the first post on the list is designated as pending approval, meaning until such approval is received the post cannot be published on the SMC. The next two posts have been approved and previously posted on the SMC.

FIG. 9B illustrates a webpage 310 with windows 311, 312 for a user to enter his profile information for the compliance network. The user is listed as having joined the compliance community, meaning he is granted the privilege to enter investment posts within the community. A member of the community may participate in many ways including: share posts with the community; upgrade, invest/co-invest, comment and save posts; view the performance of particular post; follow other community members; manage a model portfolio and get ranked amongst the community; and receive customized email notification alerts. The user can enter his profile information in the upper window 311, and enter any legal disclaimers that will accompany his posts in the lower window 312.

FIG. 9C illustrates a webpage 315 having a window 316 for a user to designate his compliance officer. Here the user has entered an email address of the officer in the window 316 and clicked “yes” 317 to indicate the officer needs to approve all of the user's submissions prior to posting. The user then hits the save button 318 to store these compliance settings in the database of the compliance module.

More specifically, when a member designates a compliance officer for their account, a record is created in the overseer table 302 of the database with the email to the compliance officer containing a randomly generated Base64 encoded token. This in turns sends a notification through SMTP (Simple Mail Transfer Protocol, an Internet standard for electronic mail (email) transmission across Internet Protocol (IP) networks) to the compliance officer stating that a member has designated them as their compliance officer. However the compliance officer will not receive notifications for approval of content until the compliance officer accepts responsibility to participate, by clicking on the approval link in the notification email.

FIG. 9D illustrates a notification email 320 sent to the designated compliance officer. When the officer decides to click on the link 321 to accept responsibility of overseeing the member account, the compliance officer is directed to a webpage on the compliance server network through HTTP (Hypertext Transfer Protocol, an application protocol for data communication for the World Wide Web) wherein the compliance module will find the compliance officer record in table 302 using the officer Id and the Base64 encoded token. Once loaded the system will flag the overseer record as accepted in the database.

FIG. 9E illustrates one example of a compliance module webpage 325 enabling a user to submit content for approval. This webpage, similar to FIG. 6, includes windows 326, 327 for entering the title and text of the content, and providing optional details 328 for adding content. Once the user clicks the submit button 329 the compliance module generates an email 330 to the compliance officer as illustrated in FIG. 9F. The module generates a record in the post table 303 where the content is saved, and it is marked noncompliant. An email 330 is sent to the compliance officer with the post details 331 as well as the option to approve 332 or deny 333 this submission. The options are submitted as buttons or links, and they include the Base64 token and the post Id allowing the system to track the officer's identity and match them with the post.

When the compliance officer clicks on the approve button 332, the officer is taken to the compliance portal where the compliance module will find the content record 303 based on the Base64 token and will attempt to approve the post. For security the module will first check that the officer attempting to approve the post is the officer designated for the post's author (the user id). At this point the post compliant flag is set to true and saved. The officer receives a confirmation 335 that it has approved the content submission (FIG. 9G).

When the compliance officer clicks on the deny button 333 (FIG. 9F), the officer is taken to the compliance portal through HTTP where the compliance module will find the content record 303 based on the Base64 encoded token and will attempt to deny the post (content). The compliance module will compare the officer's information with the post author's (user's) compliance officer. The post is then flagged as non-compliant and denied in the database 303. When a post is denied the compliance officer has an opportunity (via window 341 in webpage 340) to send a message to the user with notes describing why the post is denied. This step is not required but allows the user and compliance officer to communicate regarding the content. If the compliance officer chooses to do so (via send button 342) the message is sent to the user through SMTP (see FIG. 9H).

FIG. 9I illustrates an email 345 sent to the user indicating his submitted content has been denied by the officer. The user may edit the content and resubmit by the clicking the link 346.

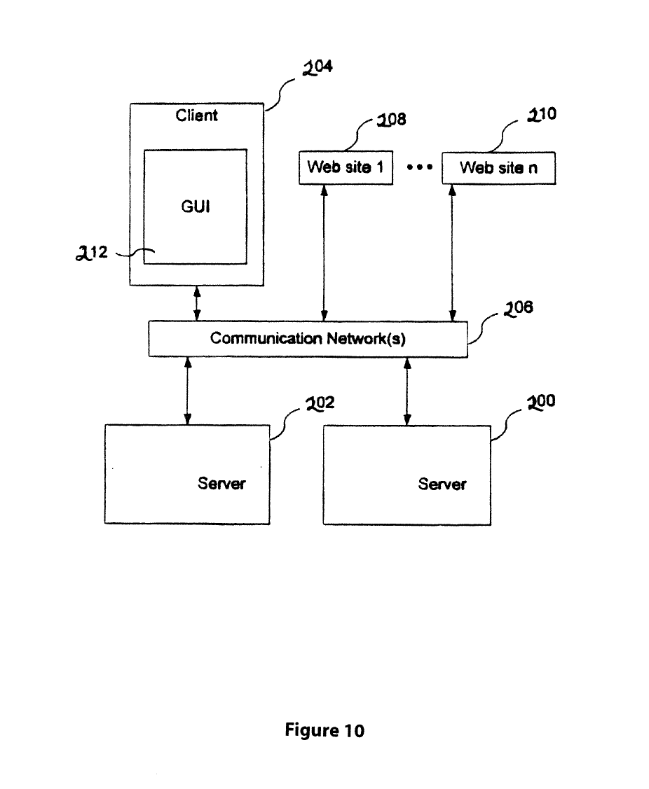

FIG. 10 is a block diagram illustrating an exemplary distributed computer system that may be used in one embodiment of the invention. This system includes one or more client computer(s) 204, servers 200, 202, web sites 208, 210, and communication network(s) 206 for interconnecting these components. Client 204 includes a graphical user interface (GUI) 212. Server 202 may perform the functions of the compliance module. Server 202 may also receive and respond to requests from client 204, e.g., to approve a particular content, and may publish or distribute content online. GUI 212 may display a plurality of content, submission or approval forms and email reply form.

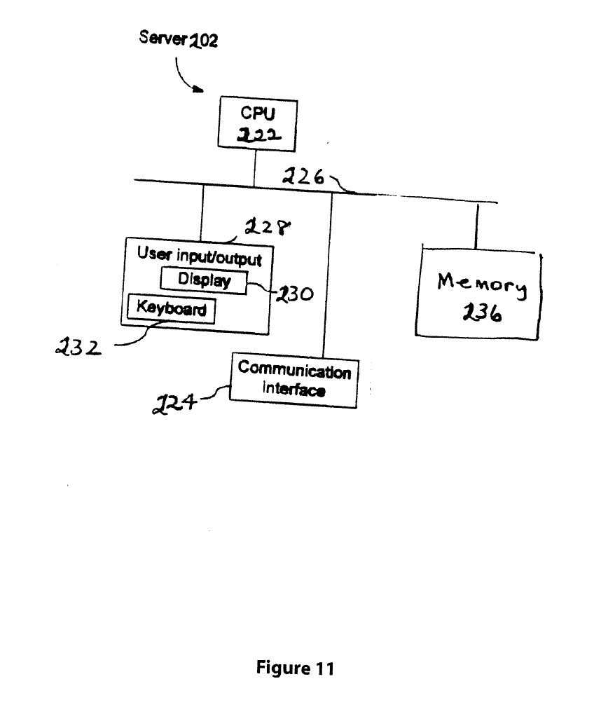

FIG. 11 is a block diagram illustrating a server 202 that can be used in one embodiment of the present invention. Server 202 typically includes one or more processing units (CPU's) 222, one or more online network or other communication interfaces 224, memory 236, and one or more communication buses 226 for interconnecting these components. Server 202 optionally may include a user interface 228 comprising a display device 230 and a keyboard 232. Memory 236 may include high speed random access memory and may also include non-volatile memory, such as one or more magnetic disk storage devices. Memory 236 may optionally include one or more storage devices remotely located from the CPU(s) 222. In some embodiments, the memory stores programs, modules and data structures, and subsets thereof.

It is to be understood that the foregoing description is intended to illustrate and not to limit the scope of the invention.

1. A method of regulating content posted by members of an online social media community (SMC) comprising:
storing, on a compliance service provider module, a designated compliance officer for regulating posts by a member of an online social media community (SMC);
receiving, on a portal of the compliance module, content submitted by the member of the SMC;
the compliance module generating and sending to the designated compliance officer an email with the content and an automated reply link designating approval or denial, prior to posting of the content on the SMC;
the compliance module awaiting receipt of an automated reply from the compliance officer with approval or denial of the content;
wherein the content is posted on the SMC only after receipt of an approval reply from the compliance officer.

2. The method of claim 1, wherein the email and automated reply are stored.

3. The method of claim 1, including:
maintaining a compliance database of associated members, designated officers and content.

4. The method of claim 1, wherein the member and compliance officers are employees of a regulated company.

5. The method of claim 1, including:
storing the email and automated reply for each content submitted by one or more members employed by a regulated company for complying with record keeping requirements of investment or financial related content of the regulated company.

6. The method of claim 1, wherein the portal of the compliance module is operative to display a designation form for entry of the designated compliance officer by the member, and a content submission form for entry of content by the member.

7. The method of claim 1, wherein the compliance module communicates with one or more SMCs for transmitting approved content to the SMC for posting.

8. The method of claim 1, wherein the member communicates with the compliance portal via a computer, server or other wired or wireless communications device.

9. The method of claim 1, wherein the compliance officer communicates with the compliance module by a computer, server or other wired or wireless communications device.

10. The method of claim 1, including:
receiving on the portal of the compliance module an email address of a compliance officer for the member; and
the compliance officer generating and sending to the compliance officer an email with an automated reply link designating approval or denial of responsibility to approve content submitted by the member;
the compliance module awaiting receipt of an automated reply from the compliance officer with approval or denial of responsibility;
wherein the compliance officer is stored on the compliance module as a designated compliance officer for the member only after receipt of an approval reply from the compliance officer.

11. The method of claim 10, including storing the approval of responsibility reply received from the compliance officer.

12. The method of claim 1, including:
the compliance module, upon receipt of an automated reply from the compliance officer with denial of the content, generates and sends an email to the member alerting the member of the denial.

13. The method of claim 1, wherein the compliance module is integrated with an SMC.

14. The method of claim 1, wherein the compliance module is separate from the SMC.

15. The method of claim 3, wherein the compliance database includes member, compliance officer, and content tables linked by a member identifier.

16. The method of claim 3, wherein the compliance database includes a token identifier for associating the compliance officer with the content submitted by the member.

17. The method of claim 1, wherein the compliance portal is operative to display a member webpage listing one or more contents submitted by the member for which an approval reply has been received or is awaiting receipt.

18. A data processing system for regulating content posted by members of an online social media community (SMC), comprising a plurality of computers interconnected by a communications network, the system comprising a plurality of system means operative to cause the system to operate in a respective plurality of different states;
a first logic means for controlling a first state in which content may be entered into said system by a member, said first logic means being operative to generate an email with the content and an automated reply link designating approval or denial of the content; and
a second logic means for controlling a second state in which content is approved or denied in response to receipt of an automated reply from a designated compliance officer for the member with approval or denial of the content;
wherein said first logic means is operative
c. to generate said email for each content submitted by the member; and
d. to send to the designated compliance officer the email with the content and automated reply designating approval or denial prior to posting the content on the SMC;
and said such second logic means is operative to await receipt of an automated reply from the designated compliance officer with approval or denial of the content, wherein the content is posted on the SMC only after receipt of an approval reply from the designated compliance officer.

19. A computer system including hardware and software for processing content submissions and communications between at least one employee of a regulated company that is a member of an online social media community (SMC) and a designated compliance officer, the system comprising:
a communications network connecting the member and the designated compliance officer of the member;
a compliance module connected to the network for processing a content submission by the member to the SMC, including generating and sending an email to an email inbox of the designated compliance officer via the network, the email including the submitted content for preapproval by the compliance officer prior to posting on the SMC;
the compliance module awaiting receipt of a reply via the network from the compliance officer and posting the content on the SMC only after receipt of a reply from the compliance officer that approves the content.
